(19) United States
(12) Patent Application Publication
(10) Pub. No.: US 2013/0168991 A1
(43) Pub. Date: Jul. 4, 2013

(54) FITTINGS DEVICE FOR A VEHICLE

(71) Applicant: Philippe Perakis, Leysin (CH)

(72) Inventor: Philippe Perakis, Leysin (CH)

(21) Appl. No.: 13/704,556

(22) PCT Filed: Jun. 14, 2011
(86) PCT No.: PCT/EP2011/059833

§ 371 Date: Feb. 11, 2013

(30) Foreign Application Priority Data
Jun. 15, 2010 (EP) EP 10165953.0

(51) Int. Cl. B60R 5/04

(52) U.S. Cl. CPC B60R 5/04
USPC 296/37.1

(57) ABSTRACT

A fittings device for a vehicle, comprising at least one box formed by at least two compartments, at least one of the compartments being fixed related to the vehicle and at least one of the compartments being mobile related to the fixed compartment, wherein the mobile compartment is connected to the fixed compartment by means of a fastening device. The fastening device comprising at least one arm pivotable around an axis connected to one of said fixed or mobile compartments, wherein said at least one arm further comprises a guiding finger configured for being guided in a groove made in the mobile or fixed compartment which is not connected to the axis of the arm, and in that said mobile compartment may be arranged above the fixed compartment or beside the fixed compartment that the top of the fixed compartment and the mobile compartment form a substantially flat surface.

### TECHNICAL FIELD

This invention relates to a device intended for the conversion of a vehicle. More specifically, such device allows the conversion of all kind of vehicle into motor home and particularly passenger vehicles.

### PRIOR ART

Vehicles that can be currently found on the market can be essentially classified into three categories, namely the passenger vehicles comprising urban, compact and family cars, the so-called people-carriers or van vehicles, also known as MPV (multi-purpose vehicles) and the habitable vehicles such as motor home or caravans.

The habitable vehicles have the advantage of being designed to easily allow their users to sleep, to cook or to perform any other activity requiring a relatively large space. However, the drawback is that these are voluminous, which involves a driving that might be sometimes difficult or uncomfortable and in particular, problems related to parking, maneuverability, height in case of obstacle such as a bridge, a tunnel, an underground car park, . . . . Moreover, the purchase price is relatively high as well as the operating cost. Furthermore, this type of vehicle is not adapted to a daily use.

The type of vehicles such as minivan, people-carriers, “ludospace”, small or large MPV have less space and can thus be used daily. Some of these are equipped with interior fittings that enable a use similar as for a motor home, i.e. it is possible to sleep and possibly eat inside the vehicle. The majority of vehicles equipped in this way is originally relatively expensive and need customized equipment, which is also expensive. For a majority of users, most of the vehicle trips are made without the need of particular equipment. The use of a vehicle converted into a motor home represents a very occasional use for this majority of users. The investment is therefore not reasonable.

In recognition of this, some firms have offered movable furniture inserted in a vehicle that allow an easy conversion of the vehicle into a motor home. One of these pieces of furniture is described in the Patent EP 0 229 556. This document describes a drawer chest comprising elements that can be taken out from the vehicle in order to form a table or retracted in the vehicle in stowed position. In this stowed position, the upper part of the piece of furniture forms a sleeping place.

The problem of any known device allowing the conversion of a vehicle into a motor home is the fact that the vehicle must have a relatively large height to allow a berth to be placed above the piece of furniture so as to make this berth usable.

The existing systems are thus exclusively designed for high profile vehicles. Being given that this type of vehicles represents only a lower percentage of vehicles commercially available, the existing removable systems represent a very limited use.

The document U.S. Pat. No. 4,826,235 describes a device providing the advantage of reducing the required height of a vehicle. This document concerns more specifically a trailer intended to include two beds, each formed by a box spring and a mattress. In a storage position, this trailer is folded away and beds are arranged one on the top of the other. In the position of use, this trailer is folded down and beds are arranged side-by-side. More particularly, the invention described in this document concerns a mechanism for allowing beds to be displaced from their storage position into their position of use. The aim of the invention is to allow an easy displacement of the beds between the two positions.

For this purpose, the lower box spring can slide on a rail. The upper box spring is pivotally attached to two pairs of parallel arms, such arms being themselves pivotally connected to the rail or to a frame different from the lower box spring.

One problem of this invention is due to the fact that when the two beds are displaced, the arms must be long enough so that the box spring corners do not interfere with each other and that the upper bed can pass from the position of use into the storage position and inversely. By using only the pivoting arms around two fixed points, it is not possible for the mattresses to be in contact with each other when they are in the position of use. To solve this problem, the recommended solution consists in a pivoting movement of the upper box spring that is independent from the sliding movement of the lower box spring. The sliding movement of the lower bed is possible by means of rails. Thereby, none of the beds is fixed in relation to the trailer.

The presence of these rails requires a large space, which involves that the device cannot be installed in the trunk of a vehicle such as a car. Furthermore, such device cannot be adapted for a use in the trunk of a car.

The present invention is intended to avoid the drawbacks of the existing systems by proposing a removable device enabling to convert almost any vehicle into motor home, including low-height vehicles, such as urban type, compact or estate cars, known as supermini, small family cars and station wagons.

### DISCLOSURE OF THE INVENTION

The aim of the invention is reached by a fittings device for a vehicle, characterized in that it comprises at least one box formed by at least two compartments, at least one of the compartments being fixed with respect to the vehicle and at least one of the compartments being mobile compared to the fixed compartment, in that the mobile compartment is connected to the fixed compartment by means of a fastening allowing a horizontal and vertical displacement of the mobile compartment, this fastening comprising at least one arm pivoting about an axis connected to one of said fixed or mobile compartments, in that said at least one arm further comprises a guiding finger arranged for being guided in a groove made in the mobile or fixed compartment which is not connected to the axis of the arm, and in that said mobile compartment can be placed at least in a first position in which it is arranged above the fixed compartment and in a second position in which it is placed near the fixed compartment in such a way that the upper parts of the fixed compartment and the mobile compartment form an substantially flat surface.

The device according to this invention offers a large storage space, in particular as important as in the prior art devices such as, for example, the one described in the document EP 0 229 556. However, unlike the prior art devices, the device of the invention can be comfortably used in almost any vehicle, including relatively low-height vehicles.

The device of the invention is also particularly interesting as it provides a wide range of use. According to different variants, this can be used to form a working surface arranged outside the vehicle, a low table, and a larger table allowing several people to sit around. It can also be used to form a bed in order to allow two people to sleep comfortably in the vehicle.

The volume of the device is large enough to allow the installation of a wash hand basin and of a clean water tank and a dirty water tank, as well as means for heating water such as a water heater. It is furthermore possible to equip the device with a kitchen stove and different utensils such as pots, table setting, etc.

As an example, the overall dimensions of a box can have a depth of 45 cm, a width of 45 cm, a height of 30 cm when both compartments are arranged side by side and a height of 60 cm in a position in which both compartments are positioned on top of each other. The overall dimensions of one sample of the device of the invention formed by two boxes arranged side by side in a vehicle present a depth of 45 cm, a width of 90 cm, and a height of 30 cm when both compartments are arranged side by side and a height of 60 in a position in which both compartments are positioned on top of each other.

Another benefit of the device of the invention is that a single person can easily convert it from a configuration into another, without using any tools. Indeed, pieces are fitted together and held under their own weight.

The whole device can be easily mounted and removed from the vehicle, even by a single person. As a first step, a base is mounted in the trunk of a vehicle and fixed to the vehicle by means of straps. In a second step, the boxes are mounted on the base and fixed to the latter. The device is generally formed by two boxes in such a way that it is not very difficult to set up one box at a time.

The dimensions of the device are such that the rear seats of the vehicle can be used when the device is in a transportation position.

### BRIEF DESCRIPTION OF THE DRAWINGS

This invention and its advantages will be better understood with reference to the enclosed drawings and to the detailed description of a particular embodiment, in which:

FIG. 1 is a front view of the device according to the invention in a first position;

FIG. 2 is a top view of the device of the invention, in the position of FIG. 1;

FIG. 3 is a profile view of the device of the invention in a second position;

FIG. 4 is a profile view similar to FIG. 3, of the device installed in a vehicle;

FIG. 5 is a profile view of the device of the invention in a third position;

FIG. 6 is a profile view similar to FIG. 5, of the device installed in a vehicle;

FIG. 7 is an upper view of the device as shown in FIGS. 5 and 6;

FIGS. 8a-8g are side views of the device of the invention in different displacement positions of an element compared with another;

FIGS. 9a-9g are schematic side views similar to FIGS. 8a-8g, showing a variant of the device of the invention;

FIGS. 10a-10e are schematic side views similar to those of FIGS. 8a-8g, showing another variant of the device of the invention; and

FIGS. 11 and 12 are profile views of the base elements that can be used with the device of the invention.

### EMBODIMENT OF THE INVENTION

With reference to the figures, the device 10 according to the present invention essentially comprises two boxes 11 arranged side by side.

In an advantageous embodiment, boxes are similar, at least with regard to their size and their overall appearance. However they can be slightly different from each other in some aspects, depending in particular on their specific equipment.

It is also possible to provide a box having a width superior to the other, for example respectively of ⅔ and ⅓ of the total width, the wide box being able for instance to be used by a single person and the combination of the wide box and of the narrow box being able to be used by two people. It is also possible to provide a device comprising only a single box.

In the following description, only one of the boxes is described, on the understanding that the other box is similar. A box according to the invention comprises two compartments 12 of which one (12a) is fixed in comparison to a vehicle in which the device is installed. More precisely, the device is usually located in the trunk of the vehicle and fixed to the floor of this trunk. The other compartment 12b is movable as compared to the fixed compartment and can be placed above the fixed compartment and at least in a position in which it is located near the fixed compartment.

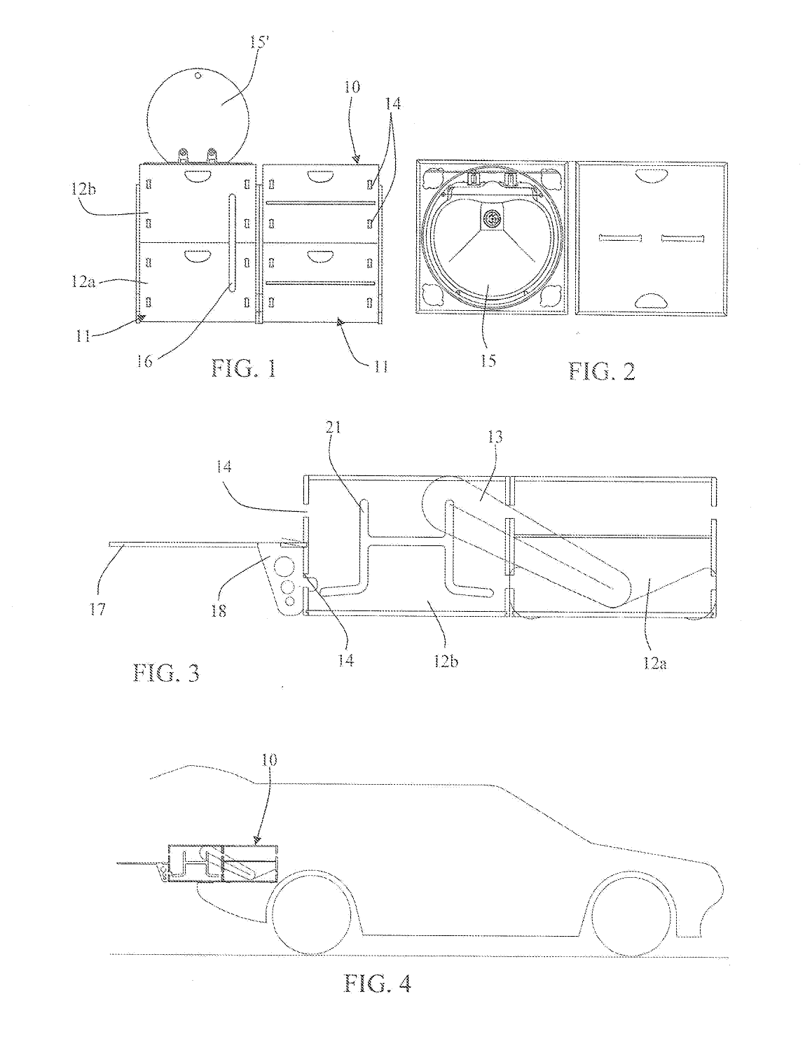

FIGS. 1 and 2 show the device of the invention in a transport position, according to a front view and an upper view respectively.

In this transport position, the mobile compartment 12b is vertically positioned on the fixed compartment 12a. Both compartments are maintained on top of each other by means of a fastening that allows the horizontal and vertical displacement of the mobile compartment. According to a preferred embodiment, the fastening means comprise arms 13 which are described in more detail below. Each compartment comprises openings 14 arranged to receive additional equipment elements, also described in more detail below.

In the embodiment showed in FIGS. 1 and 2, the mobile compartment 12b located to the left is provided with a wash hand basin 15. It is equipped with a cover 15′ in such a way that it forms a flat surface when the cover is closed. The fixed compartment 12a is intended to receive a clean water tank and a used water tank, a pump and possibly means for heating water. Both compartments comprise a passage 16 that extends in the upper part of the fixed compartment and in the lower part of the mobile compartment. This passage exceeds half of the compartment height in such a way that a tube can communicate between both compartments regardless of their respective position. This tube can be used for passing the water from the tank into the wash hand basin. It can also be used for an electrical cable for instance.

The box arranged to the right in the drawing can receive for instance cooking equipment, a kitchen stove or any further adequate equipment.

According to a preferred embodiment, the mobile compartment 12b can be moved forwards and backwards in relation to the fixed compartment. When the mobile compartment is moved backwards with respect to the vehicle, said compartment is lifted out of the vehicle trunk and can be positioned so as to form a flat surface with the fixed compartment. This can be seen in particular in FIGS. 3 and 4. In FIG. 3, both compartments are placed in such a way that they form a flat surface outside a vehicle. The mobile compartment is used to fix and maintain a shelf 17 acting as a working surface or low table. This shelf is fixed against the mobile compartment by means of brackets 18 housed in one of the openings 14 formed in one of the compartment faces. This fastening system provides a secure fit without the need of screws or any other fastening elements requiring tools. Thus, the mounting of the shelf or of its replacement by another element is very easy and can be made without any particular skills or force.

FIG. 4 represents the device of the invention in the configuration of FIG. 3, as installed in the trunk of a vehicle. In this figure, both compartments are showed at similar heights. However it is also possible to use both compartments even if a level difference exists between them. This level difference can come from the configuration of the vehicle trunk or depend on the user choice for maintaining the compartments at different heights.

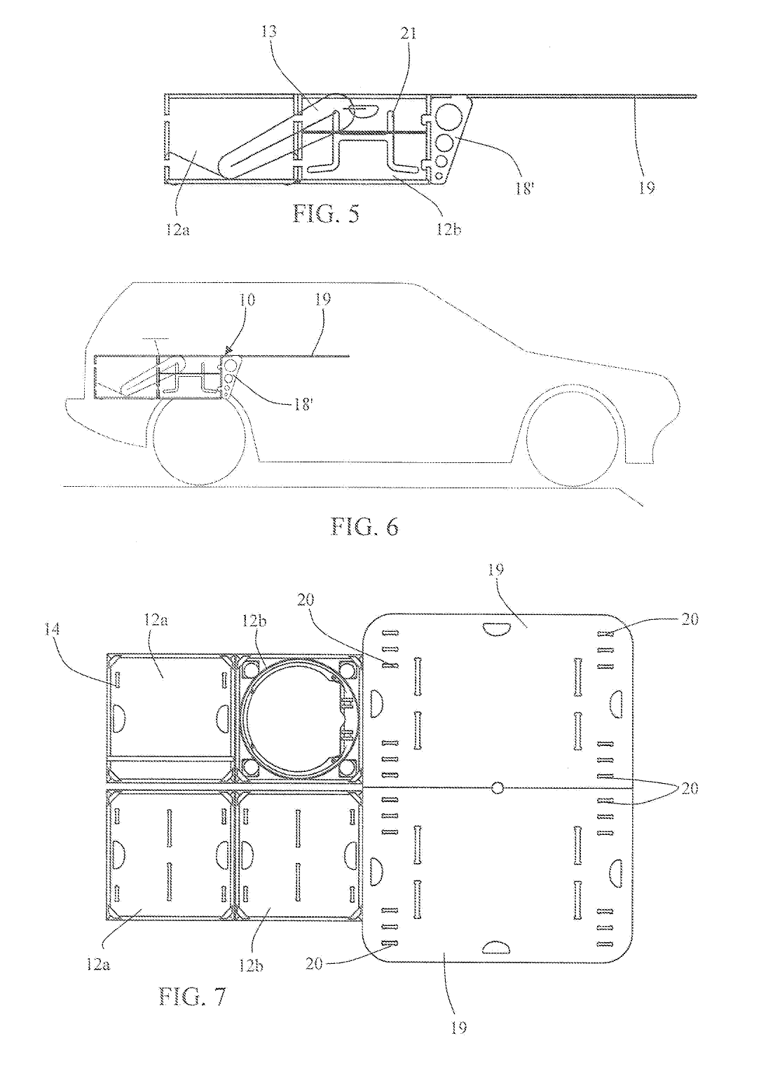

When the mobile compartment 12b is moved forwards, the latter is engaged inside the vehicle and can be positioned in such a way that it forms a flat surface with the fixed compartment. This is shown in FIGS. 5, 6 and 7. In these figures, a shelf 19 is fixed at the same level as the flat surface formed by both compartments. This shelf extends in the forward direction of the vehicle in such a way that the unit forms a flat surface that can be used as a bed.

According to a preferred variant, the bed shelves 19 comprise openings 20 located near the edges. The openings located near one of the edges are used to receive brackets 18′ intended to maintain the shelf against the mobile compartment. Openings near the opposite edge receive straps hooked to the front seats of the vehicle, for instance around the headrests, in order to prevent the shelves from swinging down under the user weight.

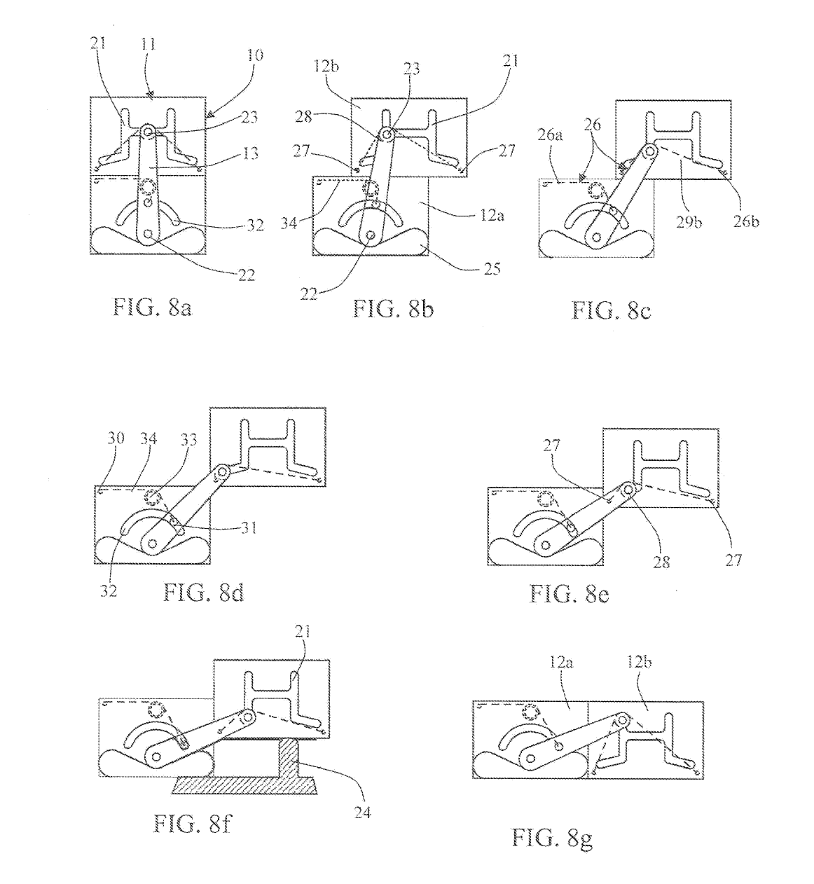

FIGS. 8a-8g, 9a-9g and 10a-10e show three embodiment variants enabling the displacement of the mobile compartment 12b compared to the fixed compartment 12a.

FIG. 8a shows both compartments in a side view, in transport position, which means that both compartments are arranged vertically on top of each other. It should be noted that, for reasons of ease of use, sides are symmetrical in such a way that the non-visible side of the compartments is symmetrical compared to the side showed in the figures.

The mobile compartment 12b comprises a groove 21. The arm 13 pivots around an axis 22 connected to the fixed compartment 12a. The arm is provided, in one area near its upper end, with a guiding finger 23 running in the groove 21.

The groove being symmetrical and centered against the side of the mobile compartment, said compartment can be moved either forwards or backwards.

FIG. 8b shows the horizontal displacement of the mobile compartment 12b in a first direction. As it can be observed, the finger 23 runs in the groove 21, in the horizontal part of said groove. When the mobile compartment 12b runs even more in this direction, the finger 23 is displaced in the vertical part of the groove. This is shown in FIG. 8c. Because of the particular shape of this groove, the mobile compartment 12b can remain against the fixed compartment 12a. The mobile compartment does not need to be held by the user or by a support to hold its position. Indeed, the combination of the support against the fixed compartment and of the shape of the groove allows obtaining such characteristic. When the edge of the mobile compartment comes into contact with the fixed compartment edge, the guiding finger 23 is placed in an extreme position of the groove; this position allows the mobile compartment to pass from the horizontal movement into its vertical displacement. This is shown by FIG. 8d.

FIG. 8e shows the vertical displacement of the mobile compartment 12b. The guiding finger 23 rises in the groove 21 and runs an opposite path. In FIG. 8f, the mobile compartment has been displaced downwards. In this figure, the edge of a car trunk 24 is shown schematically, which is lightly raised with respect to the trunk floor. The mobile compartment 12b rests on the trunk edge. Because of the particular form of the groove 21, the mobile compartment can be supported without risk of pivoting from the moment that the guiding finger 23 is placed in the vertical part of the groove 21. Thus, the device of the invention can be used regardless of the trunk height, without the need of any particular system for fastening or holding the mobile compartment on the fixed compartment.

FIG. 8g shows the case where both compartments are arranged at the same level. This can be achieved when the mobile compartment is moved towards the outside or towards the inside of the vehicle.

The lower compartment or fixed compartment 12a comprises a retaining element 25 that prevents the arm 13 from moving beyond a predefined limit. In particular, this retaining element makes it possible to limit stresses on elements, to carry out a blocking at the stroke end (FIG. 8g) and to prevent the rotation of the compartment mobile in float position (FIG. 8f).

As it can be seen in these figures, the fixed compartment is never displaced with respect to the vehicle. Moreover, the mobile compartment is attached only to the fixed compartment, which means that the arms connect the compartment fixed to the mobile compartment, without being attached to another independent structure of the fixed compartment. Despite this lack of connection to an independent structure, it is possible to move the mobile compartment so as to bring it into contact with the upper face of the fixed compartment, either with its front face or with its rear face. This can be achieved by using a groove having particular shape characteristics and a guiding finger. Thanks to this, the overall device of the invention is extremely compact and can be located in a limited space such as the trunk of a vehicle.

FIGS. 8a-8g also represent assisting means 26 for the displacement of the mobile compartment. In the disclosed embodiment, these assisting means are arranged in the fixed compartment and in the mobile compartment. Although these are not essential, these make the displacement of the mobile compartment and the handling easier. It is also possible to provide assisting means only in the fixed compartment 12a, or on the contrary, in the mobile compartment 12b.

Assisting means 26b arranged in the mobile compartment 12b comprise two fastening points 27 and a pulley 28. The fastening points 27 are arranged in the lower corners of the compartment, inside the latter. The pulley 28 is also located inside this mobile compartment, on the guiding finger 23 running in the groove 21. A stretch cord 29b connects both fastening points 27 by passing on the pulley 28.

As it can be seen in FIGS. 8a-8d, the more the mobile compartment is off-center compared to the fixed compartment, the more the stretch cord 29b is short, which means that the latter is less stretched. Thus, the horizontal displacement of the mobile compartment is simple and does not require any effort on behalf of the user.

According to FIGS. 8e-8g, it can be seen that the stretch cord 29b elongates as the mobile compartment is lowered. This means that this stretch cord applies an upward force that acts against the downward force due to the mass of such compartment. Thus, the downward movement of the mobile compartment is retained by the stretch cord 29b.

On the contrary, when the mobile compartment 12b is moved upwards from a position as shown in FIG. 8g until a position as shown in FIG. 8e, assisting means 26 help the user to lift the mobile compartment.

The assisting means arranged inside the fixed compartment 12a comprise a fastening point 30 arranged in an upper corner of the compartment and another fastening point arranged on a finger 31 connected to the arm 13. In order to allow the displacement of this finger through the wall of the fixed compartment, the latter comprises a circular arc shape opening 32. This opening can be used with the finger 31 as a guiding element.

The fixed compartment 12a further comprises a pulley 33 on one of its inner faces. A stretch cord 34 is fixed to the fastening point 30, passes on the pulley 33 and is fixed to the finger 31. As in the case of the stretch cord 29 arranged in the mobile compartment 12b, the stretch cord 34 of fixed compartment 12a helps the displacement of the mobile compartment and minimizes the apparent weight i.e. the weight felt by the user.

It is clear that other assisting means could be used such as for instance springs, cylinders, . . . . It is also possible to cushion the fall of the compartment mobile, for instance by acting on the friction between the arm and the fixed compartment.

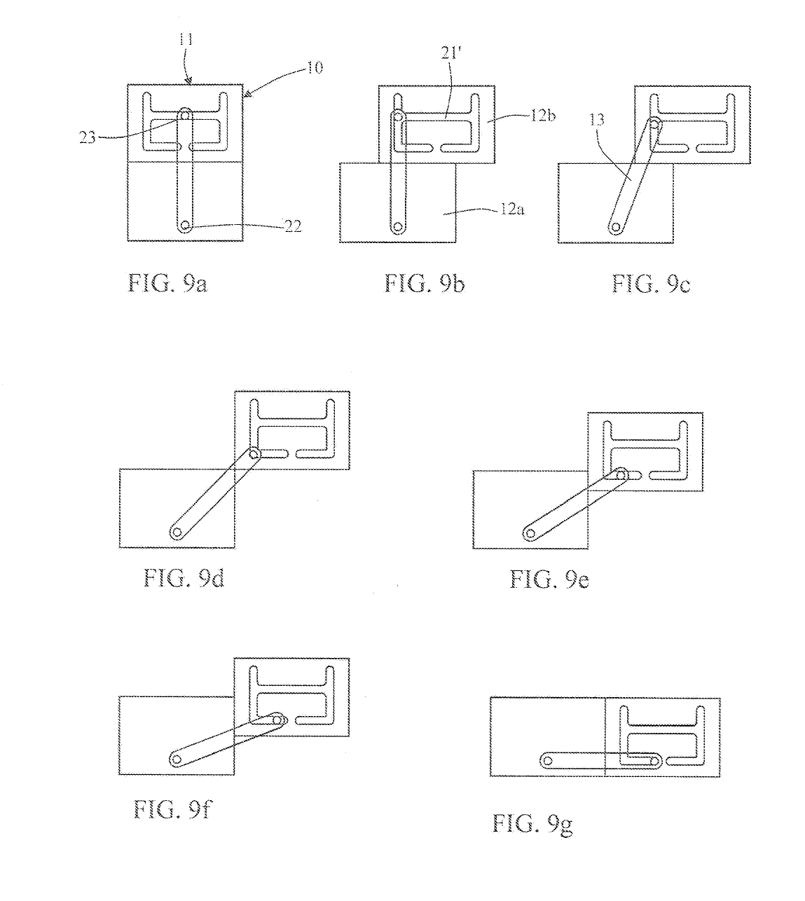

FIGS. 9a-9g illustrate a variant of the groove 21′ of the mobile compartment. In this variant, the displacement of the mobile compartment is similar to that explained in relation to FIGS. 8a-8g. However, in this example, the mobile compartment cannot be blocked in any position during its vertical displacement along the fixed compartment. This variant is thus advantageously used when both compartments can be placed at the same level or when additional means intended to hold the mobile compartment are provided.

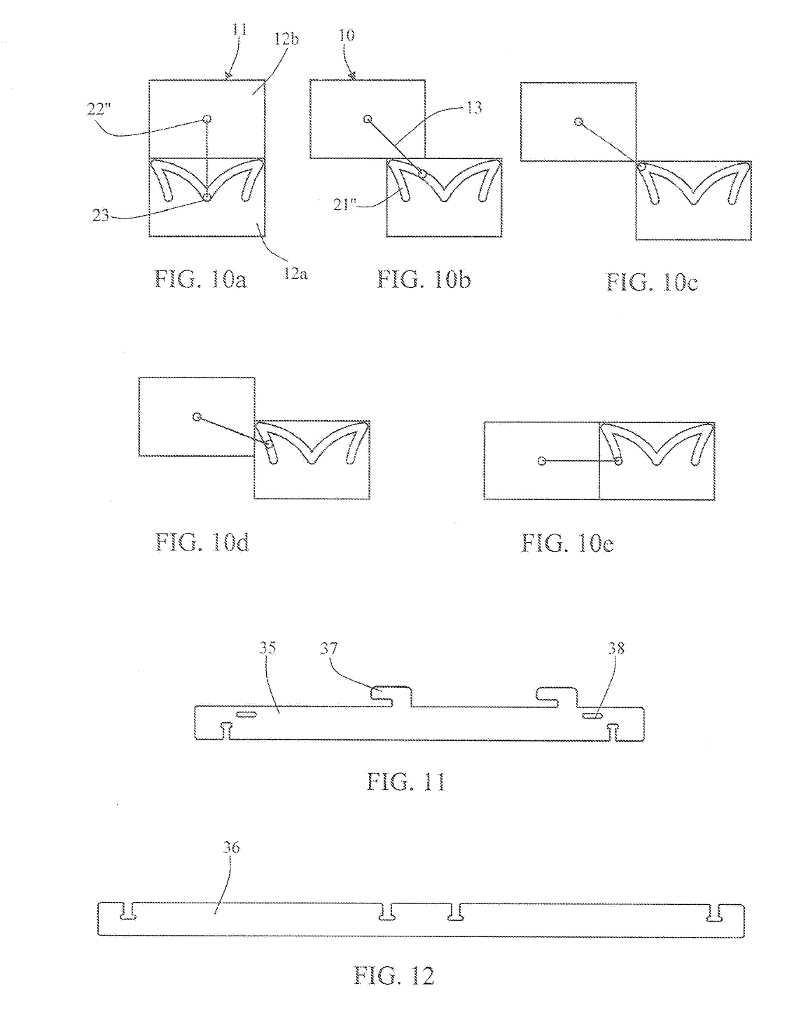

In the embodiment shown in FIGS. 10a-10e, the arm 13 pivots around an axis 22″ connected to the mobile compartment while the groove 21″ is made in the fixed compartment. As in the embodiment of FIG. 9, the mobile compartment is not self-blocking compared to the fixed compartment. It is thus advantageous to provide blocking or support means, or to use this variant on a flat surface.

Further groove shapes can also be used, as long as they allow the displacement of the mobile compartment from a position in which the latter is vertically arranged on the fixed compartment until a position in which said compartment is horizontally placed near the fixed compartment.

According to an advantageous embodiment, boxes according to this invention are held in position in a car trunk. Obviously, there are different ways to hold such boxes, in particular by directly fixing these in the car floor, through a fastening with straps or any further known means. One of the advantageous ways consists in placing the device on a base. The elements forming this base are shown in FIGS. 11 and 12. This base is formed by a frame comprising cross pieces 35 and longitudinal elements 36 that fit one into another for instance by means of a “half wood” type assembly. This assembly does not need any fastening element such as screws. The base height is determined depending on the type of vehicle in which the device is installed, more exactly depending on the depth of the trunk. In this way, by changing only the base height, it is possible to adapt the device to almost any vehicle and in particular to vehicles having very different trunk heights from each other.

The base can further comprise slides or hooks 37 arranged to co-operate with the boxes and to ensure an effective retention of the boxes on the base. Some elements of the base further comprise at least a slot 38 intended to pass a strap in order to fasten the base in the trunk of the vehicle.

The boxes are arranged side by side on the support. In a preferred way, each box comprises some slides or a profile cooperating with the slides or the hooks 37 of the base in order to ensure an effective and secure retention of the boxes on the base. This maintenance can be made fixed by means of a pin for instance, to prevent a box from moving along the support.

The materials used can be exposed to relatively important stresses. According to one preferred embodiment, the material used is formed by panels which are laminated under high pressure such as for instance Kraft paper panels impregnated with phenolic resin, so known as “HPL compact laminate” (High Pressure Laminate).

This invention has been described in one embodiment in which said invention is used for receiving camping equipment. It is clear that other uses can be provided. In particular, any use for an outdoor activity can benefit from the device of the invention. These activities can refer to sports such as cycling as well as activities such as fishing, . . . . It is also possible to use this device for other functions, for instance for storing professional material (tools, . . . ) or intervention equipment (police, firemen, . . . ) or other similar uses.

This invention has the advantage of being easily installed in or removed from a vehicle depending on the use of the vehicle. Moreover, this device can be installed in almost any vehicle regardless of its size. Another advantage is the possibility to change the device configuration in a very easy and fast manner, without any tool and by a single person.

1. A fittings device for a vehicle, comprising:
at least one box formed by at least two compartments, at least one of the compartments being fixed relative to the vehicle and at least one of the compartments being mobile relative to the fixed compartment, the mobile compartment being connected to the fixed compartment by a fastening mechanism that allows a horizontal and vertical displacement of the mobile compartment, such fastening mechanism comprising at least one arm pivotable around an axis, connected to one of said fixed or mobile compartments, said at least one arm further comprising a guiding finger arranged for being guided in a groove made in the mobile or fixed compartment which is not connected to the axis of the arm;
wherein said mobile compartment is placeable at least in a first position in which the mobile compartment is arranged above the fixed compartment and in a second position in which the mobile compartment is placed near the fixed compartment in such a way that upper parts of the fixed compartment and of the mobile compartment form a substantially flat surface.

2. The device according to claim 1, wherein the mobile compartment can be arranged near the fixed compartment, in a rear position in which the mobile compartment is arranged towards the back of the vehicle relative to the fixed compartment and in a front position in which the mobile compartment is arranged towards the front of the vehicle relative to the fixed compartment.

3. The device according to claim 1, wherein the device comprises two boxes arranged side by side.

4. The device according to claim 1, wherein said groove is made in the mobile compartment and wherein said groove is H-shaped, the lower ends of the H-shaped groove being extended by groove segments directed opposite to the center of the H-shaped groove.

5. The device according to claim 1, wherein the mobile compartment is connected to the fixed compartment by two arms arranged on opposite sides of these compartments.

6. The device according to claim 1, wherein it comprises displacement assisting means arranged to assist the displacement of the mobile compartment.

7. The device according to claim 6, wherein the displacement assisting means comprise at least a stretch cord.

8. The device according to claim 1, wherein the fixed compartment and the mobile compartment comprise a passage intended to allow the passage of a tube from one compartment to the other, regardless of the position of the mobile compartment compared to the fixed compartment.

9. The device according to claim 1, wherein the box comprises openings configured to receive furnishing elements.

10. The device according to claim 9, wherein the furnishing elements form at least one of the elements comprising a table, a work surface or a bed.

11. The device according to claim 1, wherein said at least one box is fixed on a base.
